(19) United States
(12) Patent Application Publication
(10) Pub. No.: US 2012/0315094 A1
(43) Pub. Date: Dec. 13, 2012

(54) METHOD TO PROCESS CONTAMINATED SOIL OR WASTE IN HIGH TEMPERATURE

(75) Inventor: Antero Pulkkanen, Kuusankoski (FI)

(73) Assignee: MIGLIORE OY, Kuusankoski (FI)

(21) Appl. No.: 13/579,409

(22) PCT Filed: Feb. 18, 2011
(86) PCT No.: PCT/FI2011/050153

§ 371 Date: Aug. 16, 2012

(30) Foreign Application Priority Data
Feb. 19, 2010 (FI) 20105165

(51) Int. Cl. B09C 1/06

(52) U.S. Cl. 405/128.9

(57) ABSTRACT

A method to process contaminated soil or waste in high temperature. The material (4, 5) to be processed is conducted to a first rotating drum oven (1), where the material is heated to a temperature of 230-280° C., at which components of the material evaporate and gasify. The evaporated and gasified components are discharged from the drum oven (1) and condensed. The pre-processed material (6) is conducted to a second rotating drum oven (2), where the material is heated to a temperature of 1000-1200° C., whereupon the material forms granules due to the rotating motion of the drum oven (2). The combustion gases (13) from the second drum oven are conducted through a heat exchanger (9), and oxygen-rich gas, such as air (8), is heated in the heat exchanger (9) and supplied (10 and 14) for burning the fuel (7) of the second drum oven and for heating the inner casing of the first drum oven (1). The components (12) condensed in the first drum oven (1) are recovered and/or conducted to the second drum oven (2) for fuel.

The object of the invention is a method to process contaminated soil or waste in high temperature, which is achieved in a second rotating drum oven into which the material pre-processed in a first rotating drum oven is fed. The object of the invention is described in greater detail in the preamble of the accompanying claim 1.

The material processed with the method may be oil or gas drilling waste or soil contaminated by chemicals or soil decontaminated incompletely in advance.

Using high temperatures for converting the above-mentioned materials into end products that are clean from the point of view of environmental technology has involved various problems, such as disadvantageous energy economy and poor usability of the end products.

The aim of the invention is to provide a method by means of which the above problems can be solved in such a way that, from the point of view of environmental technology, a clean end product is obtained which can be utilised, and that the external energy required by the method can be minimised by utilising recycling of the energy contained by the process.

This aim is achieved by means of the characteristics of the method disclosed in the accompanying claim 1.

The dependent claims disclose preferred embodiments and applications of the invention.

The invention is illustrated in the following with reference to the accompanying drawing, in which:

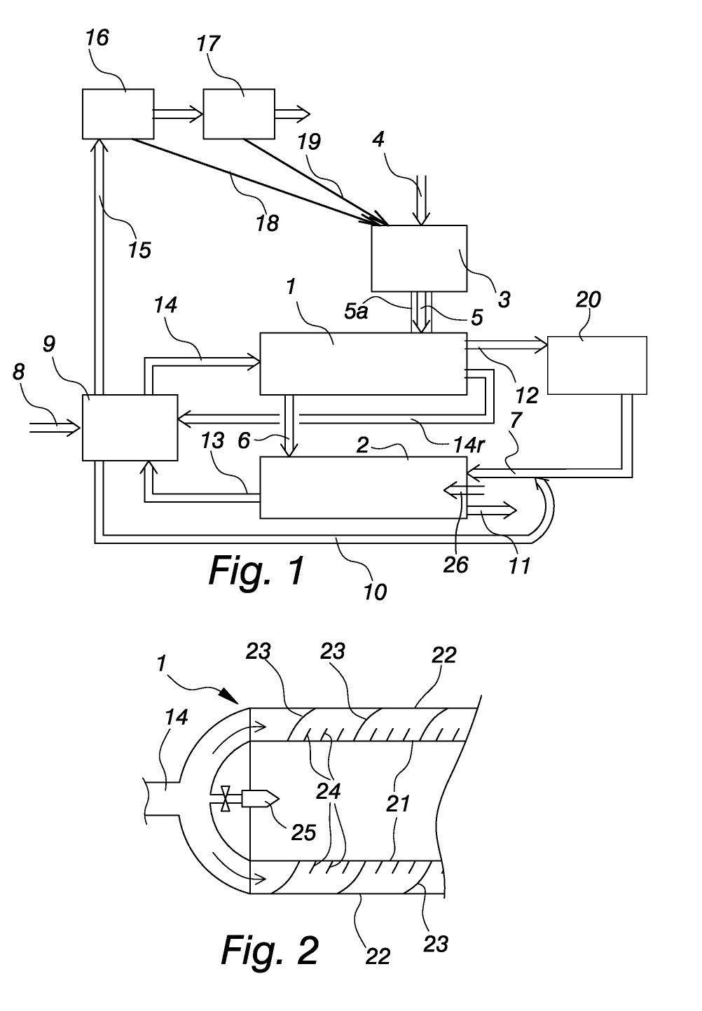

FIG. 1 shows a block diagram of the apparatus used for carrying out the method according to the invention and material flows between the blocks, and

FIG. 2 shows a longitudinal section of the forward end of the drum oven 1 of the apparatus according to FIG. 1.

The raw mass 4 of the material to be processed is fed into a mixer 3, where the material to be processed is plasticized into a homogenous mass. From the mixer 3 the plasticized raw mass 5 is conducted by means of a conveyor 5a into a first rotating drum oven 1. The conveyor 5a is preferably a micro vibratory conveyor which separates water (but not oil) from the raw mass with low energy and at the same time homogenises the mass. The mass will not adhere on the surfaces of the micro vibratory conveyor and the mass can also be raised uphill.

The drum oven 1 is heated with the hot gas obtained from the process, such as air 14, to a temperature of 200-300° C., preferably 230-280° C. The hot air 14 is blown inside the double-casing 21, 22 of the drum oven 1. The heating in the drum oven 1 will then take place according to the frying pan principle as the material rolls along the metal surface of the inner casing 21 of the rotating drum oven. In other words, heating takes place without combustion, or possible partial combustion takes place by pyrolysis. The interspace of the double-casing 21, 22 is provided with guides 23 which lengthen the distance travelled by the hot air 14. The guides may form, for example, a flow channel spirally surrounding the inner casing. In addition, there may be ribs or lamellae 24 on the outer surface of the inner casing 21, which increase the heat-exchange area. In the double-casing, the cooled air is recycled by means of a pipe 14r back to the heat exchanger 9. At the start-up stage of the process, air at about 500° C. is used in order to reach the production temperature at an accelerated speed. When hot air heats the inner drum, that is, inner casing 21 of the rotating drum oven 1 to the said temperature, the components in the mass evaporate and/or gasify. Depending on the material being processed, pyrolysis can also be utilised at this heating stage for producing heat and/or for intensifying evaporation and/or gasification. These evaporated and/or gasified components 12 are condensed in unit 20, where-upon they can be recovered in liquid form. The evaporated and/or gasified components 12 may alternatively or additionally be conducted into a second rotating drum oven 2 as fuel. Further use will depend on the material to be processed, that is, on what is evaporated and/or gasified and condensed from the material being processed.

In the drum oven 1, combustion may also be used inside the double-casing for producing heat. An auxiliary burner 25 may be used for rapid start-up of the process before the mass is fed into the drum? 1.

The condensing components may also be mixed with the gasified components and, if necessary, these gases and condensates 12 are led for combustion in a second drum oven 2, where the actual treatment process in a high temperature takes place. The mass 6 pre-processed in drum oven 1, which is at a temperature of approximately 250° C., is transferred to drum oven 2 by means of a conveyor. Drum oven 1 is preferably positioned above drum oven 2 or in general higher, so that gravity may be utilised in transferring the hot mass 6. The drum ovens 1 and 2 may naturally also be side by side.

The actual material treatment process takes place in drum oven 2, where the material is preferably heated to a temperature of 1100° C.-1200° C. The temperature must be at least about 1000° C. and it may also be higher than 1200° C. Due to the rotating motion of the drum oven 2, the material forms granules, the size of which may be adjusted in the process by the speed of rotation of the oven and inclination, among others. The granules have a sintered or vitrified surface and an inner structure full of small spherical blisters formed by gases. The heat in the drum oven 2 is produced at the start-up phase of the process, mainly by means of liquid fuels 7. The combustion gases (temperature about 700-900° C.) from the drum oven 2 are conducted to a heat exchanger 9, where the combustion gases heat the incoming oxygen-rich air 8 to a temperature of approximately 500° C. The oxygen-rich gas, such as air, heated in the heat exchanger 9 is fed through a pipe 10 to at least the second drum oven 2 in order to burn the fuel 7. The hot gas feed 14 of the drum oven 1 branches into double-casing heating gas and replacement air to be fed into the material inside the drum oven 1.

Once the combustion gases 13 from the drum oven 2 have cooled in the heat exchanger 9, the cooled combustion gases 15 are conducted to gas purification units 16 and 17, which are preferably plasma purifiers or combinations of a cyclone 16 and a washer 17. The substances 18, 19 separated from the combustion gases are fed back into the process and mixed into the material 4 being processed by means of a mixer 3.

Once the process heat has been increased to the target level, the combustion air preheated (700° C.) in the heat exchanger 9 is conducted via a pipe 10 to combustion in the drum oven 2. An even process heat is maintained by means of the main burner of the drum oven 2 by adjusting the feed of fuel 7 and combustion air 10. The heating of the material in the drum ovens 1 and 2 is intensified by means of the specularly reflecting inner surface of the drum, thus achieving an additional heating effect which decreases the overall energy requirement. At the same time, the reflections of thermal radiation heat the metal surfaces efficiently and the frying pan effect is intensified.

The material being processed travels in the drum ovens 1 and 2 in the opposite direction to the gas flows and the finished, purified end product 11 leaves the drum oven 2 below the burner, from where it is conveyed by means of a conveyor into stacks for cooling. The recovery of heat from the cooling end product 11 to the fresh combustion air 8 can also be arranged. The end product 11 is insoluble and can thus be used as building material, an aggregate for building material, as filler or relief material in earthwork and as thermal insulation. The end product is ceramicised and almost dust-free.

Especially in processing oil or gas drilling waste, the substances that have condensed in the drum oven 1 may be used effectively as additional fuel or be recovered for utilisation.

The advantages of the invention include an improved energy economy and the possibilities for utilising the end product.

1-8. (canceled)

9. A method of processing contaminated material at high temperature, the method comprising:
conducting a material to be processed to a first rotating drum oven, where the first rotating drum oven includes a double-casing that is heated by conducting hot gas inside the double-casing;
pre-processing the conducted material by heating the material in the first rotating drum oven to a first temperature, where the first temperature is within the range of about 200-300° C. and is sufficient to evaporate and gasify at least some components of the material;
conducting the pre-processed material to a second rotating drum oven;
heating the pre-processed material in the second rotating drum oven to a second temperature that is higher than the first temperature and that is sufficiently high that combustion gases are released from the heated material and the heated material forms granules as it is rotated in the second rotating drum oven;
conducting the combustion gases produced at the second drum oven through a heat exchanger;
heating an oxygen-rich gas in the heat exchanger; and
burning the combustion gases produced at the second rotating drum oven using the heated oxygen-rich gas to heat an inner casing of the double-casing of the first rotating drum oven; wherein
the gasified components from the first rotating drum oven are condensed and recovered and/or conducted to the second rotating drum oven for use as fuel.

10. The method of claim 9, wherein heating the material in the second rotating drum oven to a second temperature includes heating the material in the second rotating drum oven to at least about 1000-1200° C.

11. The method of claim 9, wherein heating an oxygen-rich gas in the heat exchanger includes heating air in the heat exchanger.

12. The method of claim 9, further comprising:
conducting the combustion gases cooled in the heat exchanger to a combustion gas purification unit; and
feeding substances separated from the combustion gases in the purification unit into the material to be processed before the material is conducted to the first rotating drum oven.

13. The method of claim 9, wherein heating the material in at least one of the first and second rotating drum ovens is enhanced by a specularly reflecting inner surface of that drum oven.

14. The method of claim 9, wherein heating the material in at least one of the first and second rotating drum ovens includes conducting the flow of material in a direction opposite to a direction of flow of hot gas.

15. The method of claim 9, wherein heating the material in the first rotating drum oven occurs at a higher level than heating the material in the second rotating drum oven, and the pre-processed material is conducted from the first drum oven to the second drum oven at least substantially by gravity.

16. The method of claim 9, wherein the material to be processed includes oil or gas drilling waste material.

17. The method of claim 9, wherein the material to be processed includes soil contaminated by one or more chemicals.

18. The method of claim 9, wherein the material to be processed includes camp or municipal waste.
